(19) United States
(12) Patent Application Publication
(10) Pub. No.: US 2025/0209649 A1
(43) Pub. Date: Jun. 26, 2025

(54) SYSTEM, APPARATUS AND METHOD FOR PERFORMING A 3D SURFACE SCAN AND/OR TEXTURE ACQUISITION USING ROLLING SHUTTER CAMERAS

(71) Applicant: CREAFORM INC., Lévis (CA)

(72) Inventors: Jean-Nicolas OUELLET, Saint-Augustin de Desmaures (CA); Éric ST-PIERRE, Lévis (CA); Félix ROCHETTE, Québec (CA); Sébastien BOUCHARD, Québec (CA); Guylain LEMELIN, Québec (CA)

(21) Appl. No.: 18/848,161

(22) PCT Filed: May 20, 2022
(86) PCT No.: PCT/CA2022/050805

§ 371 Date: Sep. 18, 2024

(51) Int. Cl. G06T 7/521; G03B 9/08; G03B 35/08; G06T 7/40; G06T 7/55; H04N 25/531

(52) U.S. Cl. CPC G06T 7/521; G03B 9/08; G03B 35/08; G06T 7/40; G06T 7/55; H04N 25/531; G06T 2207/10024; G06T 2207/10048; G06T 2207/10152

(57) ABSTRACT

A 3D scanner and a method of operating same are provided. The scanner comprises a light projector unit for projecting a structured light pattern and a set of cameras. The set of cameras includes one or more rolling shutter cameras for capturing data conveying a set of images having sensor surfaces defining a plurality of pixel lines. One or more processors are provided for sending control signals to the light projector unit to intermittently project the structured light pattern. In particular, the structured light pattern is projected when the individual pixel lines in the plurality of pixel lines are concurrently exposed to light and is otherwise either attenuated or turned off. In some implementations, a rolling shutter geometric camera is included, and the light projector unit includes a light source emits light with wavelengths in a specific range. The rolling shutter geometric camera may allow light with wavelengths in the specific range to pass through and may substantially attenuate other wavelength ranges. Optionally, a rolling shutter color camera may be included having an LCD shutter configured to intermittently permit light to pass onto sensors when the structured light pattern is projected onto the surface of the object. The rolling shutter color camera may also at least partially block light with wavelengths in the specific wavelength range.

### TECHNICAL FIELD

The present invention generally relates to the field of three-dimensional (3D) metrology, and, more specifically, to handheld 3D scanning systems and scanners. The scanners, systems and methods described in the present document may be used in a wide variety of practical applications, including but without being limited to manufacturing, quality control of manufactured pieces, and reverse-engineering.

### BACKGROUND

Three-dimensional (3D) scanning and digitization of the surface geometry of objects is commonly used in many industries and services. The shape of an object is scanned and digitized using optical sensors that measure the distance between the sensor and a set of points on the surface.

Conventionally in handheld 3D scanners, the optical sensors include one, two or more “positioning” or “geometry measurement” cameras arranged alongside one another and configured for acquiring geometric and positioning data so that measurements of surface points can be derived. In some scanners, in order to have some texture (a.k.a. color) information pertaining to that same surface, a texture (color) camera may be provided on the scanner alongside the one, two or more “geometry measurement” cameras.

In high-end metrology-graded 3D handheld scanners, since the scanner is displaced during the scanning process, it is desirable to capture an image when all pixels of a (or multiple) camera(s) are exposed at the same time and concurrently while a structured light pattern is being projected onto the surface being scanned. For that reason, global shutter cameras are typically used for the one, two or more “geometry measurement” cameras and for one or more texture camera(s). A key feature of global shutter cameras is that all pixels start and stop to integrate light at the same time and thus more accurate surface measurements may be obtained by the handheld scanner even in the presence of movement by the scanner. A drawback of global shutter cameras is that they are generally complex devices to manufacture and are more costly compared to some alternatives. While the cost may be acceptable for certain high-end applications, it is not the case for other applications, which creates an obstacle to adopting such scanners.

Another type of camera that may be used for the one, two or more “geometry measurement” cameras and texture camera is a rolling shutter camera. Rolling shutters are found in image capture devices that use complementary metal oxide semiconductor (CMOS) sensors, such as digital still and video cameras, cell phone cameras, CCTV cameras, and barcode readers. With a rolling shutter, a picture is captured by scanning across a scene rapidly, whether vertically, horizontally, or rotationally. In contrast with a global shutter where an entire frame is captured at a same instant, not all parts of the image of the scene are recorded at the same instant with a rolling shutter. Despite the time lag in capture, the entire image of the scene is displayed at once as if it represents a single instant in time.

A rolling shutter camera has the advantage of being less expensive than global shutter cameras but are only suited to applications where the camera remains substantially fixed in position while an image is being acquired. In particular, since the pixels are acquired only sequentially by a rolling shutter camera, a rolling shutter camera is not ideal in cases where there is movement of the camera during acquisition of an image, as is the case for handheld scanners where the background and the object are moving compared to the scanner's camera(s) common coordinate system. For this reason, this type of camera is ill-suited for high-end hand-held scanners. The delay in data acquisition resulting from the use of a rolling shutter camera causes temporal distortions in the image. Moreover, the use of such cameras often results in a low contrast between ambient light and an illuminating pattern of light emitted by the scanner due to the comparatively long time during which the pixels are exposed to light.

Against the background described above, it is clear that there remains a need in the industry to provide improved solutions to low-cost handheld 3D scanners that alleviate at least some of the deficiencies in application of rolling shutter cameras to handheld 3D scanners.

### SUMMARY

This Summary is provided to introduce a selection of concepts in a simplified form that are further described below in the Detailed Description. This Summary is not intended to identify all key aspects and/or essential aspects of the claimed subject matter.

The present disclosure presents handheld scanners and associated methods and systems that use rolling shutter cameras for metrology measurements as the one, two, three or more “geometry measurement” cameras. To diminish the effect of the temporal delays of rolling shutter cameras, the handheld scanner is configured so that activation of the projector of a structured light pattern is delayed until the pixels of the cameras are concurrently active and exposed to light. Following this, after a specific time period, the structured light pattern is deactivated. This process is repeated multiple times during the scan in order to acquire texture, geometry and positioning data over multiple frames.

In some implementations, infrared (IR) light sources may be used by the projector for the projected light pattern and IR light emitting diodes (LEDs) may be used to illuminate positioning targets on or near a surface being scanned. The use of IR light may assist in addressing the problem of insufficient contrast between the projected pattern and ambient light which occurs as a result of a long period for integration of light of the rolling shutter camera (when compared to global shutter cameras). In some implementations, an IR bandpass or longpass filter is used in front of the rolling shutter geometric camera lens to reject wavelengths of light other than IR. The use of IR projected light advantageously does not conflict with the use of a color camera as part of the scanner.

In some embodiments, the handheld scanner may include a color camera positioned alongside the one, two, three or more “geometry measurement” cameras. Like the geometry measurement cameras, the color camera is also configured as a rolling-shutter camera. Additionally, the color camera may, in some implementations, be equipped with a liquid crystal device (LCD) shutter configured to permit light to pass through and be captured by the camera sensor at certain specific time intervals and block light during other time intervals. A shortpass filter (or band stop filter or bandpass filter designed to transmit only the visible spectrum 400-700 nm approximately) used with the color camera may allow white light to be incident on the LCD shutter while blocking light in the IR spectrum range. The LCD shutter may be configured to transmit white light to acquire a color texture image either synchronized with the geometry measurement cameras or with a delay from the acquisition of the geometry measurement cameras. In a specific implementation, the LCD shutter may comprise a single optical cell that covers the entire display area and can be toggled between an open state (a clear state allowing light to pass through) and a closed state (an opaque state that partially or fully blocks light from passing through). The different states may be achieved in different manners known in the art such as, for example, by applying a square wave drive voltage to open and close the LCD shutter.

According to one aspect of the disclosure, a scanner is provided for generating 3D data relating to a surface of a target object comprises a) a scanner frame structure on which is mounted a set of imaging modules including: i. a light projector unit for projecting a structured light pattern onto the surface of the target object, ii. a set of cameras positioned alongside the light projector unit, said set of cameras including one or more rolling shutter cameras for capturing data conveying a set of images including reflections of the light pattern projected onto the surface of the target object, the one or more rolling shutter cameras having sensor surfaces defining a plurality of pixel lines, and b) one or more processors in communication with the set of imaging modules for receiving and processing the data conveying the set of images, wherein the one or more processors are further configured to send control signals to the light projector unit to intermittently project the structured light pattern in accordance with a specific sequence.

Some specific embodiments may include one or more of the following features: the one or more processors may be configured for sending control signals to the light projector unit to intermittently project the structured light pattern in accordance with the specific sequence to cause the light projector unit to toggle between: i. an activated pattern state, during which the light projector unit projects the structured light pattern onto the surface of the target object, and ii. a deactivated pattern state, during which the light projector unit: 1) omits to project the structured light pattern onto the surface of the target object, or 2) projects a substantially attenuated version of the structured light pattern. The sensor surfaces of the one ore more rolling shutter cameras may be activated in accordance with an operating pattern as part of a capture cycle, the operating pattern being characterized by: a. specific time periods during which the individual pixel lines in the plurality of pixel lines are concurrently exposed for a current specific capture cycle, and b. other time periods distinct from the specific time periods during which specific subsets of the individual pixel lines in the plurality of pixel lines are read and cease to be exposed for the current specific capture cycle, wherein the specific subsets the individual pixel lines omit at least one of the individual pixel lines in the plurality of pixel lines. The specific subsets the individual pixel lines may omit at least some of the individual pixel lines in the plurality of pixel lines. The activated pattern state of the light projector unit may at least partially coincide with the specific time periods during which the individual pixel lines in the plurality of pixel lines are concurrently exposed for the current specific capture cycle. The deactivated pattern state of the light projector unit may at least partially coincide with the time periods during which subsets of the individual pixel lines in the plurality of pixel lines are read and cease to be exposed for the current specific capture cycle. The one or more processors may be configured for: a. sending a reset signal to the one ore more rolling shutter cameras to start a new specific capture cycle for the plurality of pixel lines during which pixel lines in the plurality of pixel lines sequential begin to be exposed, b. following a first delay period after the sending of the reset signal, sending an activation control signal to the light projector unit to cause it to toggle into the activated pattern state, c. following a second delay period after the sending of the activation signal to the light projector unit, sending a deactivation control signal to the light projector unit to cause it to toggle into the deactivated pattern state. In some implementations, the light projector unit may include a light source for configured for emitting light with wavelengths in a specific wavelength range. The one or more rolling shutter cameras may include at least one rolling shutter geometric camera for generating image data to derive 3D measurements of the surface of the object, the at least one rolling shutter geometric camera being configured for: a. allowing light with wavelengths in the specific wavelength range to pass through onto the sensor surfaces, b. substantially attenuating light in spectrums outside the specific wavelength range. The light source may be configured to emit at least one of a white light, an infrared light and a blue light. In a very specific implementation, the specific wavelength range may be a infrared wavelength range. The light source may be configured to emit light having wavelengths between 405 nm and 1100 nm. The light source may be embodied in a variety of different devices including, for example but without being limited to, a laser and one or more light emitting diodes (LEDs). The one or more rolling shutter cameras may include at least one rolling shutter geometric camera for generating image data to derive 3D measurements of the surface of the object. The at least one rolling shutter geometric camera may include at least two rolling shutter geometric camera. The rolling shutter geometric camera may include a near infrared camera and/or may include an infrared filter configured to let infrared light pass and to substantially attenuate light in spectrums outside infrared.

In some embodiments, the one or more rolling shutter cameras may further include a rolling shutter color camera for generating image data to derive texture information associated with the surface of the object. The rolling shutter color camera may comprise a liquid crystal device (LCD) shutter. For example, the color rolling shutter camera comprises a. a sensor, b. a lens, and c. wherein the liquid crystal device (LCD) shutter is positioned between the sensor and the lens. The one or more processors may be configured for sending control signals to the LCD shutter for toggling the LCD shutter between an open state and a closed state, wherein in the open state the LCD shutter is translucent and wherein in the closed state the LCD shutter is at least partially opaque. In some specific implementations, in the closed state the LCD shutter may be fully opaque so that light incident on the LCD shutter is substantially blocked from passing through the LCD shutter. The toggling of the LCD shutter between the open state and the closed state may at least partially coincides with the light projector unit toggling between the activated pattern state and the deactivated pattern state so that: a. the LCD shutter is in the open state at least partially concurrently while the light projector unit is in the activated pattern state, b. the LCD shutter is in the closed state at least partially concurrently while the light projector unit is in the deactivated pattern state. The light projector unit may be a first light projector unit projecting light of a first type including the structured light pattern, and the scanner may comprise a second light projector unit including a second projector light source configured for projecting light of a second type onto the surface on the object. The second projector light source is a white light source and wherein the light of the second type is a white light. The second projector light source may include one or more LEDs and/or lasers, for example. The rolling shutter color camera may comprise a filter for blocking at least in part wavelengths of light corresponding to wavelength of light projected by the first light projector unit, for example the filter may be configured to block light in the infrared spectrum. The one ore more rolling shutter cameras in the set of cameras may be mounted to have fields of view at least partially overlapping with one another. The one or more rolling shutter cameras may include two rolling shutter cameras, three rolling shutter cameras or more cameras. In some very specific implementations, the rolling shutter cameras may include at least two rolling shutter geometric cameras and at least one rolling shutter color camera.

In some embodiments, the one or more processors may be further configured to send control signals to the light projector unit to intermittently project the structured light pattern in accordance with the specific sequence, wherein the specific sequence is a periodic sequence so that the light projector unit intermittently projects the structured light pattern onto the surface of the object at regular time intervals. In some implementations, the one or more processors may be configured for processing the set of images including the reflections of the structured light pattern to perform a 3D reconstruction process of the surface of the target object. In some alternative implementations, the one or more processors are configured for transmitting the data conveying the set of images including the reflections of the structured light pattern to a remote computing system distinct from the scanner, the remote computing system being configured for performing a 3D reconstruction process of the surface of the target object using the data conveying the set of images including the reflections of the light pattern. In some specific practical implementations, the scanner may be a handheld scanner or a fixed-mounted scanner, for example.

According to another aspect of the disclosure, a scanning system is provided for generating 3D data relating to a surface of a target object, the scanning system comprising: a. a scanner as described above; b. a computing system in communication with said scanner, the computing system being configured for: i. performing a 3D reconstruction process of the surface of the target object using the data conveying the set of images including the reflections of the structured light pattern captured by the scanner; and ii. rendering on a graphical user interface displayed on a display device a visual representation of at least portion of the surface of the target object resulting from the 3D reconstruction process.

According to another aspect of the disclosure, a method is provided for generating 3D data relating to a surface of a target object using a 3D scanner, the 3D scanner having a set of imaging modules including a light projector and a set of cameras, the light projector being configured to project a structured light pattern onto the surface of the target object, the set of cameras including one or more rolling shutter cameras for capturing data conveying a set of images including reflections of the structured light pattern projected onto the surface of the target object, the one or more rolling shutter cameras having sensor surfaces defining a plurality of pixel lines, the method comprising a. sending control signals to the light projector unit to cause it to intermittently project the structured light pattern according to a specific sequence by toggling the light projector unit between: i. an activated pattern state, during which the light projector unit projects the structured light pattern onto the surface of the target object, ii. a deactivated pattern state, during which the light projector unit: 1) omits to project the structured light pattern onto the surface of the target object; or 2) projects a substantially attenuated version of the structured light pattern; b. wherein occurrences of the activated pattern state of the light projector unit coincide at least in part with time periods during which the plurality of pixel lines are concurrently exposed in a same capture cycle; c. processing the set of images to perform a 3D reconstruction process of the surface of the target object.

Some specific embodiments may include one or more of the following features: the sensor surfaces of the one ore more rolling shutter cameras are activated in accordance with an operating pattern as part of a current specific capture cycle, the operating pattern being characterized by: a. specific time periods during which the individual pixel lines in the plurality of pixel lines are concurrently exposed in a current specific capture cycle, and b. other time periods distinct from the specific time periods during which specific subsets of the individual pixel lines in the plurality of pixel lines are read and cease to be exposed for the current specific capture cycle, wherein the specific subsets the individual pixel lines omit at least one of the individual pixel lines in the plurality of pixel lines. The specific subsets the individual pixel lines may omit at least some of the individual pixel lines in the plurality of pixel lines. The activated pattern state of the light projector unit may at least partially coincide with the specific time periods during which the individual pixel lines in the plurality of pixel lines are concurrently exposed for the current specific capture cycle. The deactivated pattern state of the light projector unit at least partially coincides with the time periods during which subsets of the individual pixel lines in the plurality of pixel lines are read and cease to be exposed for the current capture cycle. In some emblements, the method may further include: a. sending a reset signal to the one ore more rolling shutter cameras to restart a new specific capture cycle for the plurality of pixel lines during which pixel lines in the plurality of pixel lines sequential begin to be exposed for the new specific capture cycle, b. following a first delay period after the sending of the reset signal, sending an activation control signal to the light projector unit to cause it to toggle into the activated pattern state, c. following a second delay period after the sending of the activation signal to the light projector unit, sending a deactivation control signal to the light projector unit to cause it to toggle into the deactivated pattern state.

In some specific embodiments, the one or more rolling shutter cameras may include a rolling shutter color camera for generating image data to derive texture information associated with the surface of the object, and the rolling shutter color camera may in some cases comprise a liquid crystal device (LCD) shutter. The method may comprise sending control signals to the LCD shutter for toggling the LCD shutter between an open state and a closed state, wherein in the open state the LCD shutter is translucent and wherein in the closed state the LCD shutter is at least partially opaque. The toggling the LCD shutter between the open state and the closed state may at least partially coincide with the light projector unit toggling between the activated pattern state and the deactivated pattern state so that: a. the LCD shutter is in the open state at least partially concurrently while the light projector unit is in the activated pattern state, b. the LCD shutter is in the closed state at least partially concurrently while the light projector unit is in the deactivated pattern state.

In some embodiments, the one or more processors may be further configured to send control signals to the light projector unit to intermittently project the structured light pattern in accordance with the specific sequence, wherein the specific sequence is a periodic sequence so that the light projector unit intermittently projects the structured light pattern onto the surface of the object at regular time intervals. In some implementations, the method may comprise processing the set of images including the reflections of the structured light pattern to perform a 3D reconstruction process of the surface of the target object. In some alternative implementations, the method may comprise transmitting the data conveying the set of images including the reflections of the structured light pattern to a remote computing system distinct from the scanner, the remote computing system being configured for performing a 3D reconstruction process of the surface of the target object using the data conveying the set of images including the reflections of the light pattern.

According to another aspect of the disclosure, a computer program product is provided including program instructions tangibly stored on one or more tangible computer readable storage media, the instructions of the computer program product, when executed by one or more processors, cause a 3D scanner to perform operations to generate 3D data relating to a surface of a target object, the 3D scanner having a set of imaging modules including a light projector and a set of cameras, the light projector being configured to project a structured light pattern onto the surface of the target object, the set of cameras including one or more rolling shutter cameras for capturing data conveying a set of images including reflections of the structured light pattern projected onto the surface of the target object, the one or more rolling shutter cameras having sensor surfaces defining a plurality of pixel lines, the operations implementing the method described above.

According to another aspect of the disclosure, a scanner is provided for generating 3D data relating to a surface of a target object. The scanner comprises a scanner frame structure on which is mounted a set of imaging modules including (i) a light projector unit for projecting a structured light pattern onto the surface of the target object, the light projector unit having a light source configured for emitting light with wavelengths in a specific wavelength range; and (ii) a set of cameras positioned alongside the light projector unit, the set of cameras including one or more rolling shutter cameras for capturing data conveying a set of images including reflections of the structured light pattern projected onto the surface of the target object, the one or more rolling shutter cameras having sensor surfaces defining a plurality of pixel lines, said at least one rolling shutter geometric camera being configured for (1) allowing light with wavelengths in the specific wavelength range to pass through onto the sensor surfaces; and (2) substantially attenuating light in spectrums outside the specific wavelength range. The scanner further comprises one or more processors in communication with the set of imaging modules for receiving and processing the data conveying the set of images, wherein the one or more processors are further configured to send control signals to the light projector unit to intermittently project the structured light pattern in accordance with a specific sequence to cause the light projector unit to toggle between an activated pattern state, during which the light projector unit projects the structured light pattern onto the surface of the target object, and a deactivated pattern state, during which the light projector unit omits to project the structured light pattern onto the surface of the target object, or projects a substantially attenuated version of the structured light pattern.

According to another aspect of the disclosure, described is a scanner for generating 3D data relating to a surface of a target object, the scanner comprising (a) a scanner frame structure on which is mounted a set of imaging modules including (i) a light projector unit for projecting a structured light pattern onto the surface of the target object, (ii) a set of cameras positioned alongside the light projector unit, said set of cameras including one or more rolling shutter cameras for capturing data conveying a set of images including reflections of the light pattern projected onto the surface of the target object, the one or more rolling shutter cameras having sensor surfaces defining a plurality of pixel lines, wherein the one or more rolling shutter cameras include at least 1) a rolling shutter geometric camera; and 2) a rolling shutter color camera comprising a liquid crystal device (LCD) shutter for generating image data to derive texture information associated with the surface of the object. The scanner further comprising one or more processors in communication with the set of imaging modules for receiving and processing the data conveying the set of images, wherein the one or more processors are further configured to send control signals to the light projector unit to intermittently project the structured light pattern in accordance with a specific sequence to cause the light projector unit to toggle between (i) an activated pattern state, during which the light projector unit projects the structured light pattern onto the surface of the target object, and (ii) a deactivated pattern state, during which the light projector unit (1) omits to project the structured light pattern onto the surface of the target object, or (2) projects a substantially attenuated version of the structured light pattern.

All features of exemplary embodiments which are described in this disclosure and are not mutually exclusive can be combined with one another. Elements of one embodiment or aspect can be utilized in the other embodiments/aspects without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

The above-mentioned features and objects of the present disclosure will become more apparent with reference to the following description taken in conjunction with the accompanying drawings, wherein like reference numerals denote like elements and in which:

FIGS. 1A and 1B are illustrations of 3D imaging system configurations in accordance with specific examples of implementations of the invention;

FIG. 2 is a perspective view of a handheld 3D scanner in accordance with a specific example of implementation;

FIGS. 3A and 3B are diagrams illustrating pixel capture of a global shutter camera (FIG. 3A) and a typical rolling shutter camera (FIG. 3B);

FIG. 4 is a diagram illustrating pixel line behavior over time of a rolling shutter camera that may be used in connection with the handheld 3D scanner of FIG. 2 in accordance with a specific example of implementation;

FIG. 5 is a functional block diagram of components of a 3D handheld scanner including two (2) rolling shutter cameras in accordance with a first specific example of implementation;

FIG. 6 is a flow chart illustrating a method for using one of the two (2) rolling shutter cameras of the 3D handheld scanner shown in FIG. 5 in accordance with a specific example of implementation;

FIG. 7 is a functional block diagram of components of a 3D scanner including two (2) rolling shutter cameras and a color rolling shutter camera in accordance with a second specific example of implementation;

FIG. 8 is a flow chart illustrating a method for using one of the two (2) rolling shutter cameras and the rolling shutter color camera of the 3D handheld scanner shown in FIG. 7 in accordance with a specific example of implementation;

FIG. 9 is a functional block diagram of a handheld 3D scanner of the type depicted in FIG. 2 in accordance with a specific example of implementation.

FIG. 10 shows a functional block diagram of a processing system for the scanner of FIG. 2 in accordance with a specific example of implementation.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

A detailed description of one or more specific embodiments of the invention is provided below along with accompanying Figures that illustrate principles of the invention. The invention is described in connection with such embodiments, but the invention is not limited to any specific embodiment described. The scope of the invention is limited only by the claims. Numerous specific details are set forth in the following description in order to provide a thorough understanding of the invention. These details are provided for the purpose of describing non-limiting examples and the invention may be practiced according to the claims without some or all of these specific details. For the purpose of clarity, technical material that is known in the technical fields related to the invention has not been described in great detail so that the invention is not unnecessarily obscured.

The present disclosure presents handheld scanners and associated methods and systems that use rolling shutter cameras for metrology measurements as the one, two, three or more “geometry measurement” cameras. To diminish the effect of the temporal delays of rolling shutter cameras, the handheld scanner is configured so that the intermittent activation of the projector of a structured light pattern is delayed until the pixels of the cameras are concurrently active and exposed to light. Following this, after a specific time period, the structured light pattern is deactivated. This process is repeated multiple times during the scan in order to acquire geometry and positioning data over multiple frames.

Infrared (IR) light sources may be used by the projector for the projected light pattern and IR light emitting diodes (LEDs) may be used to illuminate positioning targets on or near a surface being scanned. The use of infrared (IR) light may assist in addressing the problem of insufficient contrast between the projected pattern and ambient light which occurs as a result of a long period for integration of light of the rolling shutter camera and longer period of exposure to light (when compared to global shutter cameras). In some applications, an IR filter may be used in front of rolling shutter camera lens to better select reflected IR light.

In some embodiments, the handheld scanner may include a color camera positioned alongside the one, two, three or more “geometry measurement” cameras that also is configured as a rolling-shutter camera. The color camera may be equipped with a liquid crystal device (LCD) shutter configured to permit light to pass through and be captured by the rolling shutter camera sensor at certain specific time intervals and block light during other time intervals. A shortpass filter may allow white light to be incident on the LCD shutter but largely exclude IR radiation. The LCD shutter may be configured to transmit the incident white light to acquire a color texture image either synchronized with the geometry measurement cameras or with a delay from the acquisition of the geometry measurement cameras. In a specific implementation, the LCD shutter may comprise a single optical cell that covers the entire display area and can be toggled between an open state (a clear state allowing light to pass through) and a closed state (an opaque state that partially or fully blocks light from passing through). The different states may be achieved in different manners known in the art such as, for example, by applying a square wave drive voltage to open and close the LCD shutter.

### Definitions

Herein, a “pixel line” refers to single linear array of connected pixels within an array of pixels. An array of pixels is comprised of a set of pixel lines, wherein a set of pixel lines includes two, three or more pixel-lines.

### 3D Measurements

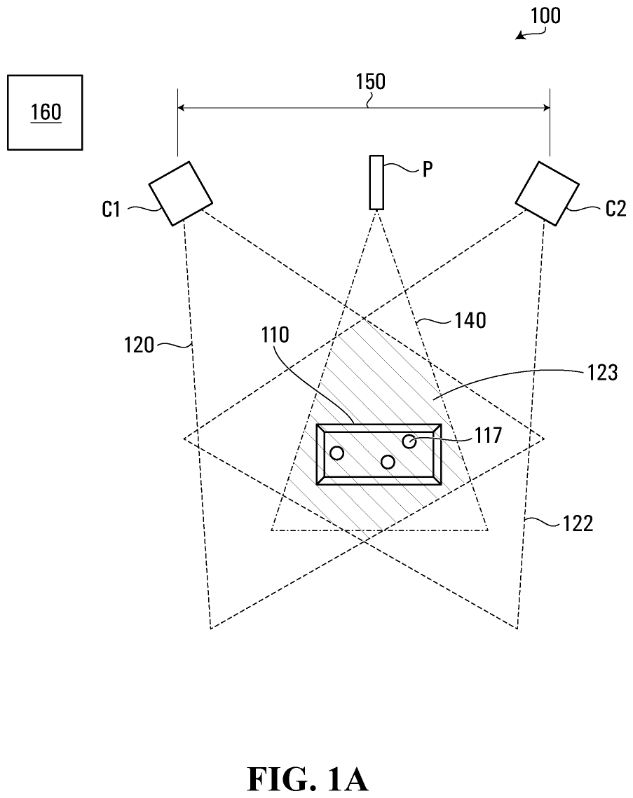

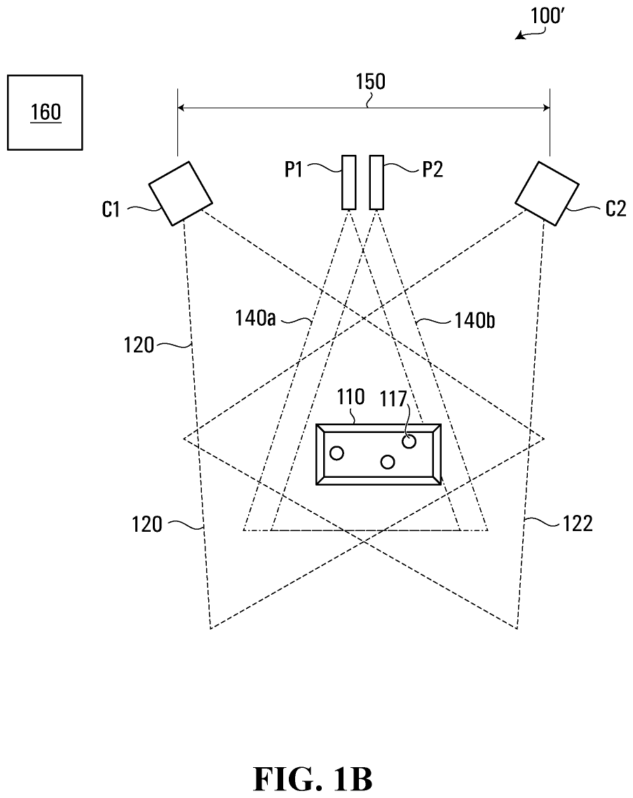

FIG. 1A is a functional block diagram showing components of a set of imaging modules of a scanner. As depicted, the set of imaging modules may include a light projector unit P and a set of cameras, e.g., two cameras, wherein the light projector unit P is mounted between the two cameras C1, C2, which in turn are separated by a baseline distance 150. The camera C1 has a field of view 120 and the camera C2 has a field of view 122. The light projector unit P projects a pattern within a respective field of projection 140. The fields of view 120, 122 and the field of projection 140 have an overlapping field 123 in which an object 110 to be scanned is placed. In FIG. 1, the light projector unit P includes a single light projector, although two or more light projector units are also possible (as is described with respect to FIG. 1B). The light projectors can have a single light source that is configured to emit one of infrared light, white light, green light, red light, or a blue light, e.g., light with wavelengths in a specific wavelength range. In some other embodiments, the light projector unit P is configured to emit light having wavelengths between 405 nm and 1100 nm. In practical implementations, the light projector unit P may include one or more light sources comprised of a laser (such as a vertical-cavity surface-emitting laser (VCSEL), a solid-state laser, and a semiconductor laser) and/or one or more LEDs, for example. The light projector unit P can include a programmable light projector unit that can project more than one pattern of light. The light projector unit P can be configured or programmed to project many sheets of light that appear as parallel light stripes, near-parallel light stripes, or sets of intersecting curves or other patterns.

Using the 3D scanner 100 with at least one processor 160, 3D points can be obtained after applying a suitable computer-implemented method where two images of a frame are captured using the two cameras C1, C2. In metrology, with a hand-held scanner, the two images are captured nearly simultaneously, typically less than 1 ms, meaning that there is no relative displacement between the scene and the 3D scanner 100 during the acquisition of the images or that this relative displacement is negligible. The cameras are synchronized to either capture the images at the same time or sequentially during a time period during which the relative position of the 3D scanner 100 with respect to the scene remains the same or varies within a predetermined negligible range. Such simultaneous capture is typically carried out using cameras with global shutters, which take an image when all pixels of each camera are exposed to incident light at the same time as when the pattern of light is projected from the light projector unit P.

The 3D scanner 100 is configured to obtain distance measurements between the 3D scanner 100 and a set of points on the surface of the object 110 of interest. Since from a given viewpoint the 3D scanner 100 can only acquire distance measurements on the visible or near portion of the surface, the 3D scanner 100 is moved to a plurality of viewpoints to acquire sets of distance measurements that cover the portion of the surface of the object 110 that is of interest. Using the 3D scanner 100, a model of the object's surface geometry can be built from the set of distance measurements and rendered in the coordinate system of the object 110. The object 110 has several object visual targets 117 affixed to its surface and/or on a rigid surface adjacent to the object 110 that is still with reference to the object 110. In some specific practical implementations, to properly position the scanner 100 in space, the object visual targets 117 are affixed by a user to the object 110, although the object visual targets 117 may also be omitted.

In the embodiment of FIG. 1B, the imaging module of another embodiment of a 3D scanner 100′ has two light projector units P1, P2 that are used to produce different light patterns on the surface of the object 110 (e.g., different sources or types of light, and/or different patterns). In some embodiments, the light projector unit P1 is an IR light projector configured to emit IR light within a respective field of projection 140a, the IR light being a structured light pattern. Light projector unit P2 is a white light projector configured to emit white (visible) light within a respective field of projection 140b. The white light emitted by projector unit P2 can be a structured light pattern, or single cone of light that fills the field of projection 140b. In some embodiments, the system can alternately project light from each light projector unit P1, P2, or can simultaneously project a light from each light projector unit P1, P2.

The cameras C1, C2 and the light projector unit P or light projector units P1, P2 are calibrated in a common coordinate system using methods known in the art. In some practical implementations, films performing bandpass filter functions may be affixed on the camera lenses to match the wavelength(s) of the projector P. Such films performing bandpass filter functions may help reduce interference from ambient light and other sources.

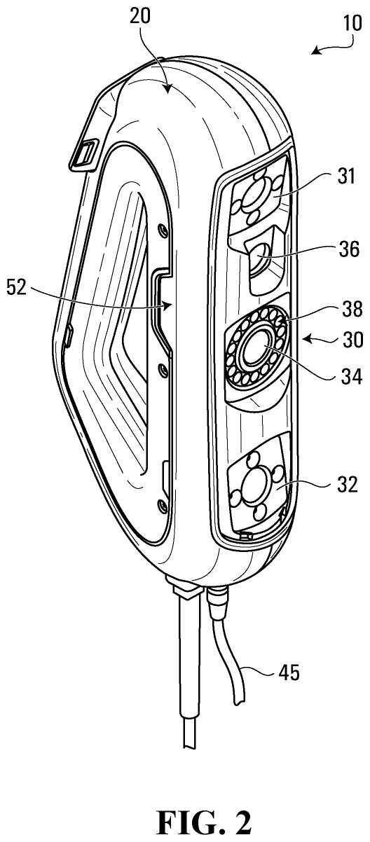

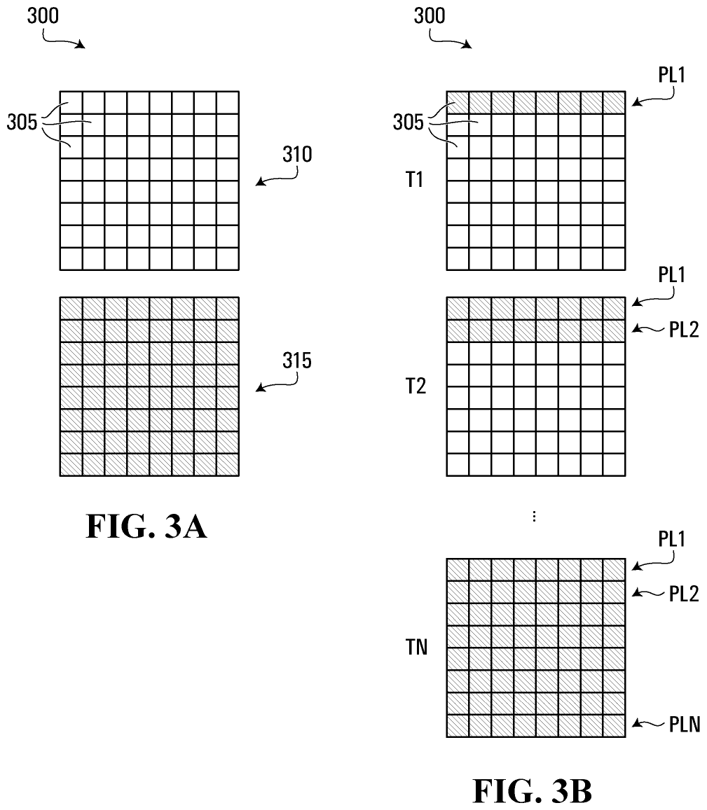

FIG. 2 shows an embodiment where the 3D scanner 100 in FIG. 1A or 3D scanner 100′ in FIG. 1B is implemented as a handheld 3D scanner 10. The handheld 3D scanner 10 includes a set of imaging modules 30 that are mounted to the frame structure 20 of the scanner, arranged alongside one another so that the field of view of the modules at least partially overlap (as in FIGS. 1A and 1B). In the embodiment shown, the set of imaging modules 30 comprises three cameras, namely a first camera 31 (equivalent to camera C1 in FIGS. 1A and 1B), a second camera 32 (equivalent to camera C2 in FIGS. 1A and 1B) as well as a third camera 34. Although not shown, a fourth camera is also possible, as is a single camera. The set of imaging modules 30 also includes a projector unit 36 comprising a light source (equivalent to light projector unit P in FIGS. 1A and P1 in FIG. 1B). The projector unit 36 may include a second projector unit on the main member 52, (equivalent to light projector units P1 in P2 in FIG. 1B). In some embodiments, the projector unit 36 can include two different light sources, e.g., light sources that can emit IR and white light, respectively. The two different light sources can be part of the same projector unit 36 or can be embodied as separate units.

In the handheld 3D scanner, one or more LEDs 38 can also be included. The LEDS 38 can be configured to all emit the same type of light as each other or be configured to emit different types of light. For example, some LEDs 38 can emit white light (e.g., the LEDs 38 closest to the third camera 34) while others of the LEDS 38 can emit IR light (e.g., LEDs 38 closest to the first and second cameras 31, 32). In one embodiment, the LEDs 38 are configured to emit IR radiation of the same or similar wavelength as the light projector unit 36.

In some embodiments, the type of cameras used for the first and second cameras 31, 32 are monochrome cameras and will depend on the type of the light source of the projector unit 36. In some embodiments, the first and second cameras 31, 32 are monochrome or color visible spectrum and near infrared cameras and the projector unit 36 is an infrared light generator or near-infrared light generator. The first and second cameras 31, 32 may implement any suitable shutter technology, including but not limited to: rolling shutters, full frame shutters and electronic shutters and the like. Specific embodiments of the shutters used with first and second cameras 31, 32 are discussed in detail below.

In some implementations, the third camera 34 may be a color camera (also called a texture camera). The texture camera may implement any suitable shutter technology, including but not limited to, rolling shutters, global shutters, and the like. Specific embodiments of the shutters used with the third camera 34 are discussed in detail below.

The first camera 31 is positioned on the main member 52 of the frame structure 20 and alongside the projector unit 36. The first camera 31 is generally oriented in a first camera direction and configured to have a first camera field of view (120 in FIGS. 1A and 1B) at least partially overlapping with the field of projection 140 or fields of projection 140a, 140b (of FIGS. 1A and 1B) of the projector unit 36. The second camera 32 is also positioned on the main member 52 of the frame structure 20 and may be spaced from the first camera 31 (by baseline distance 150) and from the projector unit 36. The second camera 32 is oriented in a second camera direction and is configured to have a second camera field of view (122 in FIGS. 1A and 1B) at least partially overlapping with the field of projection of the projector unit 36 and at least partially overlapping with the first field of view 120.

The third camera 34 (e.g., the texture camera or color camera) is also positioned on the main member 52 of the frame structure 20 and, as depicted, may be positioned alongside the first camera 31, the second camera 32, and the projector unit 36. The third camera 34 (e.g., the texture camera) is oriented in a third camera direction and is configured to have a third camera field of view at least partially overlapping with the field of projection, with the first field of view 120, and with the second field of view 122.

A data connection 45 (such as a USB connection) can transfer data collected by the first camera 31, the second camera 32 and the third camera 34 to be processed by a computer processor and memory remote from the handheld 3D scanner 10. Such a remote computer processor and memory are in communication with the processor 160 (shown in FIGS. 1A and 1B) associated with the handheld 3D scanner 10.

### Rolling Shutters

The first and second cameras 31, 32 as well as the third camera 34 which is a texture camera use rolling shutters. FIGS. 3A and 3B illustrate the behavior of global shutter and rolling shutter cameras, respectively. Within such cameras, the sensing surface such as sensor surface 300 is organized in an array of individual sensing elements or pixels 305. The sensor surface 300 can be a CMOS sensor.

In FIG. 3A, a global shutter is used to permit or prevent exposure of the entire sensor surface 300 to a light signal reflected from a sample. Accordingly, all sensor pixels begin and end light exposure simultaneously, and the sensor toggles between the off position 310 and the on position 315. The global shutter can be thought of as a snapshot exposure mode, where all pixels 305 of the array are exposed to light simultaneously, enabling a freeze frame capture of a scene.

In FIG. 3B, the sensor surface 300 (e.g., a CMOS sensor) is exposed to a light signal reflected from a sample using a rolling shutter. The rolling shutter collects the data of the sensor surface one pixel line at a time. As illustrated, at a first time T1 a new capture cycle begins where the sensor surface 300 begins acquiring a new frame or image. The first pixel line PL1 of the sensor surface 300 begins (or is reset from a previous cycle to begin) newly acquiring signal, followed by a second pixel line PL2 at time T2, continuing in sequence until all the pixels have begun acquiring a new signal as part of the same capture cycle at time TN. The pixel lines are shown as proceeding from top to bottom but can proceed from bottom to top or left to right or right to left. Accordingly, there are specific time periods during which all the individual pixel lines are concurrently exposed in the same capture cycle and other time periods distinct from the specific time periods, during which specific subsets of the individual pixel lines are read and cease to be concurrently exposed for the current capture cycle. The specific subsets of the individual pixel lines omit at least one or some of the individual pixel lines.

Rolling shutter cameras have simpler electronic components than global shutter cameras and so are less expensive. However, such cameras are not normally used in metrology applications. In a rolling shutter camera, there is a temporal delay between exposure of each pixel line of the camera. While the temporal delay is very small between each adjacent pixel lines, the time delay between the first line and last line (e.g., TN-T1) can be significant. While such a delay may not cause problems in a completely stationary setup (where the cameras in the scanner, background, and object are all fixed and stationary with respect to each other), in mobile hand-held scanners the background and the object are moving compared to the scanner cameras' common coordinate system. The time delay between capture of the first line and last line of a rolling shutter can cause distortions resulting in an unacceptably large measurement error. Additionally, the long exposition time as each pixel line in turn begins acquiring a signal can create issues due to diminished contrast of pattern of light emitted over the ambient light.

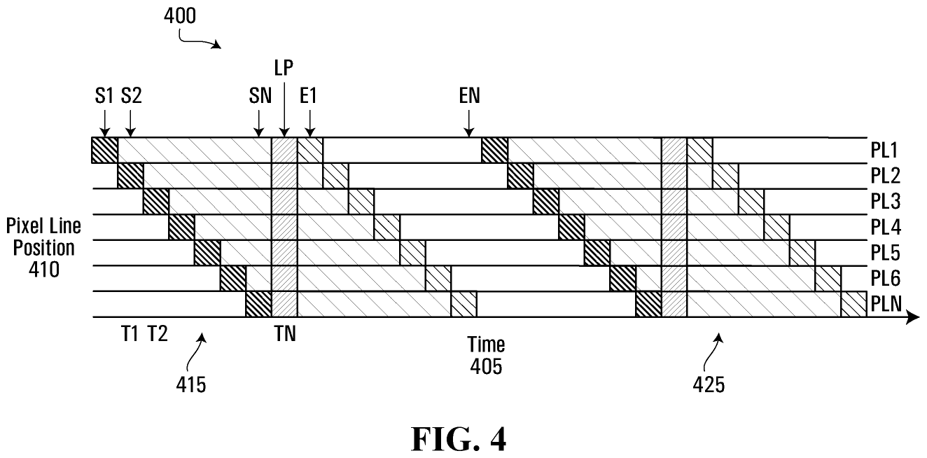

FIG. 4 is a diagram 400 illustrating a method of controlling the behavior of the handheld 3D scanner 10 where first, second, and third cameras 31, 32, 34 are rolling shutter cameras. The method includes control of light signal capture pixel line by pixel line within the first, second, and third cameras 31, 32, 34 and thereby avoids the problem of temporal distortions caused by rolling shutter cameras. Implementation of the method causes the cameras to perform in a similar fashion as do global shutter cameras, where all the camera pixels are exposed to light at the same time within the same capture cycle. The method allows the handheld 3D scanner 10 to perform as if it included global shutter cameras, but for the price of rolling shutter cameras.

In FIG. 4, the diagram 400 has an X axis 405 that represents time and a Y axis 410 that is the pixel line position within the first and second cameras 31, 32, or the third camera 34. Seven pixel lines are illustrated, but the reader will understand that many more than seven pixels lines are controlled by the method illustrated by diagram 400, for example 1944 pixel lines or more.

Diagram 400 illustrates two different capture cycles 415, 425. Capture cycles 415, 425 are substantially identical to each other. Each capture cycle 415, 425 represents the acquisition of a frame or image. In each capture cycle the pixel lines are set or reset to start capturing data for a new image, the subsequently captured data read out, and any delay between cycles allowed to elapsed before the next cycle is begun.

Beginning a first capture cycle 415, a first signal S1 is sent (e.g., by the processor or a processor within the camera itself) to reset data of the first pixel line PL1. The first pixel line PL1 then begins newly integrating the light signal incident on the first pixel line PL1 starting at T1, to form the first line of a new image or frame. Next, a second signal S2 is sent to reset the second pixel line PL2. The second signal S2 can be sent at the same time T1 that PL1 begins capture for the current capture cycle, or immediately before or after that time. Following the second signal S2, the second pixel line PL2 resets and begins newly acquiring and integrating the light signal incident on the second pixel line PL2 at T2. A series of signals are sent that trigger consecutive pixel lines to reset and begin a new capture until resetting of the final pixel line PLN is triggered by signal SN and the final pixel line begins integrating light to form the last image line for the new cycle TN. The signals S1 to SN are sent in a timed sequence, for example, at regular intervals. The interval between S1 and S2 can be 0.0073 ms and the interval between S1 and SN 14.2 ms (for an array with 1944 pixel lines). The time between S1 and E1 can be 17.7 ms, and E1 to EN (which is equivalent to S1 to SN) be 14.2 ms.

At this point, all the pixels in the pixel lines PL1 to PLN are reset and concurrently acquiring data belonging to the current capture cycle 415. Only once all the pixels lines PL1 to PLN are concurrently acquiring data for the current capture cycle is the projector unit 36 (and optionally any LEDs) triggered to toggle from the deactivated pattern state during which it omits to project the structured light pattern onto the surface of the target object (or projects a substantially attenuated version of the structured light pattern), to the activated pattern state, during which the light projector unit projects the structured light pattern onto the surface of the target object. For example, the one or more processors send control signals to the light projector unit to cause it to toggle into the activated pattern state when all of the pixel lines are concurrently exposed to light for the current frame/image (and also to toggle into a deactivated pattern state when one or more pixel lines have ceased being exposed to light for the current frame/image). In another example, the one or more processors send control signals to the light projector unit to cause it to toggle into the activated pattern state after a sufficient time has elapsed since S1 to allow for all of the pixel lines to be concurrently exposed to light.

The light projected from the projector unit is reflected back from the object and received during a projected structured light pattern time period, LP. The projected structured light pattern time period LP is shown as near simultaneous with time TN where all the pixels are reset and concurrently acquiring data for the current capture cycle, and in fact takes place just after time TN (e.g., immediately after, in response to detecting all the pixel lines are concurrently exposed to light, or in response to detecting that the required time period has elapsed). The projected structured light pattern as reflected back from the object thus will be detected simultaneously by all pixels during the projected light pattern time period LP. The time period LP associated with the activated pattern state coincides with the time period during which the pixel lines have been reset and concurrently are exposed to light in the same capture cycle, and the time period associated with the deactivated pattern state of the projector unit coincides with all other time periods. The time period LP associated with the activated pattern state can be, for example, 3.5 ms.

The structured light pattern projection is then turned off in conjunction with a stop signal sent to read out the data captured by the pixels of the camera for the current frame by the processor or a processor within the camera itself. First, an end signal E1 is read out the data of the just detected by the first pixel line PL1 (e.g., since time T1). Subsequent end signals are sent to sequentially read out all the pixel lines until the final end signal EN. At this point the data of the pixels in the pixel lines PL1 to PLN have been read. A new capture cycle 425 then begins, where the previous sequence of signals and pixel reset and readout is repeated. A cycle delay time may elapse between the end of one cycle and the beginning of the next cycle (e.g., a cycle delay time between the time of EN signal for cycle 415 and the time of the S1 signal of cycle 425). The cycle delay time may be chosen to determine the number of cycles per second. These capture cycles can occur multiple times a second during a metrology measurement, for example, 15, 30, 60 or more times per second.

Typically, high-resolution rolling shutter cameras have memory sufficient to contain only a few pixel lines of an image and transfer the data immediately as they a new cycle of being exposed to light. For portability, it is desirable for data transfer to be carried out with a single USB connection. For a 3D scanner such as described with respect to FIG. 1A to FIG. 4 that uses two or more high resolution (e.g., 5 megapixel) cameras with a minimum exposure time of 17.7 ms that capture images at the same (or nearly the same) moment the data would saturate a single USB 3.0 connection which typically does not have enough bandwidth. The rolling shutter cameras that are embodied as first, second, and third cameras 31, 32, 34 are accordingly equipped with a memory buffer large enough to contain a whole camera image and so not saturate a single USB connection. The cameras are equipped with enough memory that the entire image (taken during a cycle) is storable on the camera before the data is transferred from the camera (e.g., sent to the system's processor). The first, second, and third cameras 31, 32, 34 cameras can transfer the data simultaneously or sequentially.

### IR Projected Light

The method as illustrated in FIG. 4 results in a relatively long time period during which each pixel line is exposed to light during a single cycle (e.g., the time period of E1-S1). The projected structured light pattern time period LP during which the projected light is emitted is relatively short compared to this relatively long duration of each pixel line's exposure time. If the light projected and detected is in the visible spectrum, a very low signal to noise ratio is the result. To overcome the noise, the contrast of the emitted pattern of light over the ambient light is maximized, by making use of IR light. IR light can be used as there are relatively few ambient sources of IR in a typical environment.

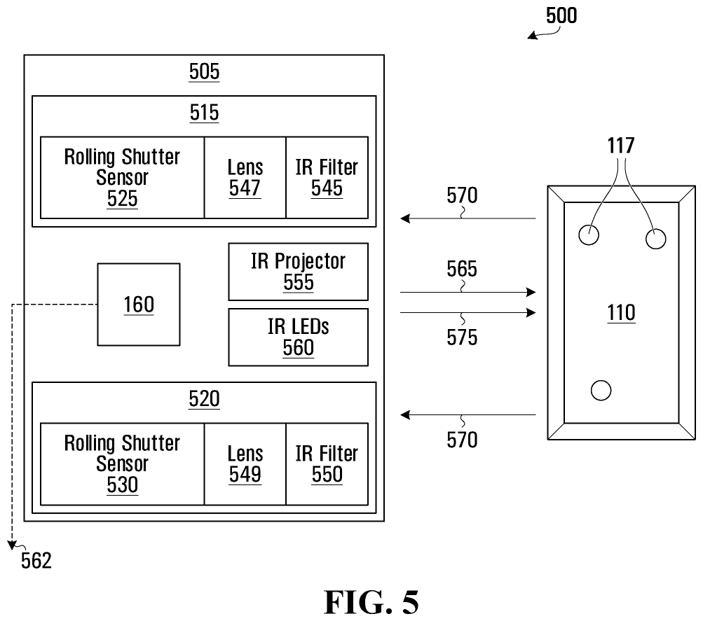

FIG. 5 illustrates an example image capture scenario 500 using an exemplary IR rolling shutter scanner 505. The IR rolling shutter scanner 505 is a variation on the handheld 3D scanner 10 of FIG. 2, where the imaging modules include a first and second camera 31, 32 with the third camera 34 omitted.

The IR rolling shutter scanner 505 has two rolling shutter cameras 515, 520 (equivalent to first and second cameras 31, 32 in FIG. 2). Each of the rolling shutter cameras 515, 520 has a rolling shutter sensor 525, 530 (each having an array of pixels 305 such as the array described with respect to FIGS. 3A and 3B) that is exposed to the object 110 being scanned by a rolling shutter mechanism. An IR filter 545, 550 (e.g., a bandpass or longpass filter) is placed in front of the rolling shutter sensors 525, 530 and restricts the wavelengths of light incident on the lenses 547, 549 of the rolling shutter cameras 515, 520 that is transmitted to the rolling shutter sensors 525, 530. As is known in the art, the IR filters 545, 550 block out most wavelengths of light in the light received 570 by the rolling shutter cameras 515, 520, leaving only the desired portion of the infrared spectrum to be captured by the rolling shutter sensors 525, 530. Suitable lenses 547, 549 can be placed in front of or behind the IR longpass filters 545, 550. Accordingly, the rolling shutter cameras 515, 520 allow light with wavelengths in the specific wavelength range (IR range) to pass through onto the sensor surfaces, while substantially attenuating light outside the specific wavelength range.

In the IR rolling shutter scanner 505, an IR projector 555 is used as a projector unit 36 (of FIG. 2) and emits a pattern of light 565 in IR wavelengths. The IR filters 545, 550 ensure that the pattern of light 565 emitted by the IR projector 555 corresponds to the majority of the received light 570 reflected by the object 110 and incident on the rolling shutter cameras 515, 520, thereby increasing the contrast in the received light 570 between the desired signal corresponding to the emitted pattern of light 565 and ambient light. The use of IR light and an IR projector 555 makes it possible to use rolling shutter cameras 515, 520 in the context of a handheld 3D scanner by solving the issue with low pattern to ambient light contrast and temporal distortion.

In the IR rolling shutter scanner 505 one or more IR LEDs 560 are used, which are also configured to emit IR light 575 towards the object 110. The IR light from the IR LEDs 560 is used to illuminate object visual targets 117 on or near to the object 110. The IR light 575 from the IR LEDs 560 is emitted simultaneously with the light the pattern of light 565 emitted by the IR projector 555 to simultaneously get data from the object visual targets 177 and the object itself.

In the IR rolling shutter scanner 505, one or more processors 160 control signals and process data. Data is transferred from the IR rolling shutter scanner 505 along data communication line 562.

In some embodiments, the IR projector 455 emits light at a wavelength of 850 nm. Other wavelengths are possible, for between 405 nm and 1100 nm. The IR LEDs 560 also can emit light at a wavelength of 850 nm. Other wavelengths are possible, for between 405 nm and 1100 nm.

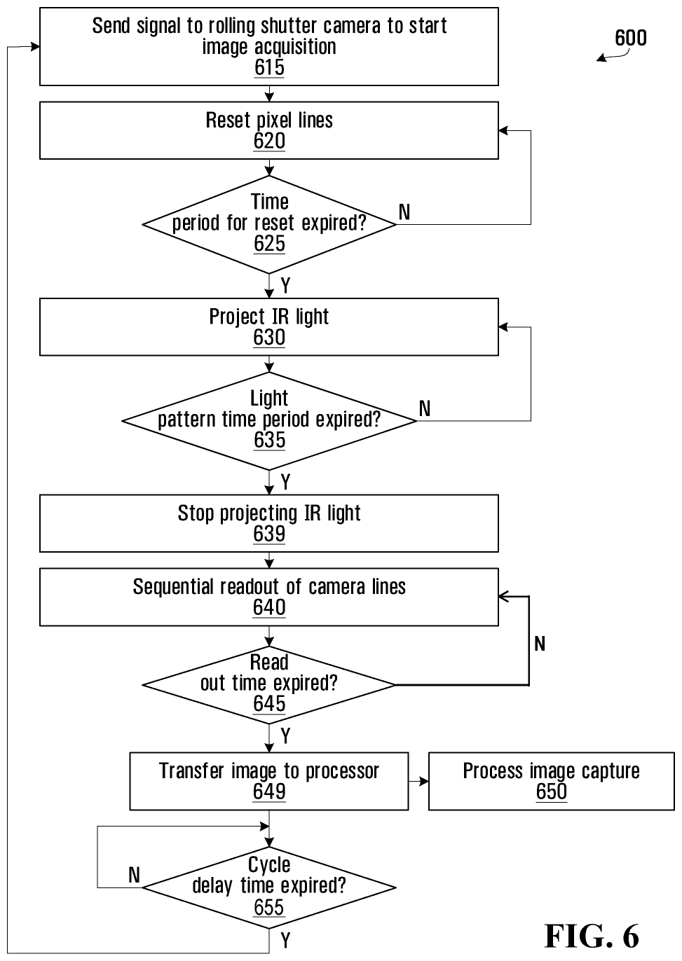

FIG. 6 illustrates steps of using the IR rolling shutter scanner 505 of FIG. 5 taking into account the rolling shutter behavior as discussed with respect to FIG. 4. At step 615, a signal is sent (e.g., by the one or more processors 160) to cause the rolling shutter cameras 515, 520 to start a new cycle of capturing light. Within the cameras, a signal is sent to cause the pixel line to reset and begin a new cycle of being exposed to light in both rolling shutter cameras 515, 520, step 620. The time period required for the reset of all the pixel lines of the rolling shutter cameras 515, 520 is allowed to elapse (step 625). Then, the IR projector 555 is toggled into the activated pattern state so that IR light is projected by the IR projector 555 (and in some embodiments, by the IR LEDs 560 as well); the projected IR light is reflected from the object and received at the rolling shutter cameras 515, 520 during the structured light pattern time period (LP), step 635. A signal is sent to then cause the IR projector 555 to cause it to toggle into the deactivated pattern state and stop projecting IR light (and IR LEDs 560), step 639. Accordingly, the activated pattern state of the light projector unit at least partially coincides with the specific time period during which the pixel lines in the rolling shutter camera(s) are concurrently exposed, and the deactivated pattern state of the light projector unit at least partially coincides with the time period during which subsets of the pixel lines are read and cease to be exposed for the current capture cycle. A signal is sent to then cause the rolling shutter cameras 515, 520 to read out the data captured since each pixel line was reset, step 640. The data readout from the pixels to the memory of the camera continues until complete (step 645). The data, which represents the entire image, is transferred from the camera to the processor 160, step 649. The image captured is then processed, step 650. In the processing step, the one or more processors processing the set of images including the reflections of the IR light pattern to perform a 3D reconstruction process of the surface of the target object. The processing includes determining a measurement relating to the surface of the object based on a correspondence between signals received from the first and second cameras, using triangulation and stereoscopic principles. After step 649 where the data is transferred out, the system determines if enough time has elapsed to restart the image capture cycle. When the cycle delay time has expired, the image capture cycle restarts at step 615 (step 655).

### LCD—Color Capture

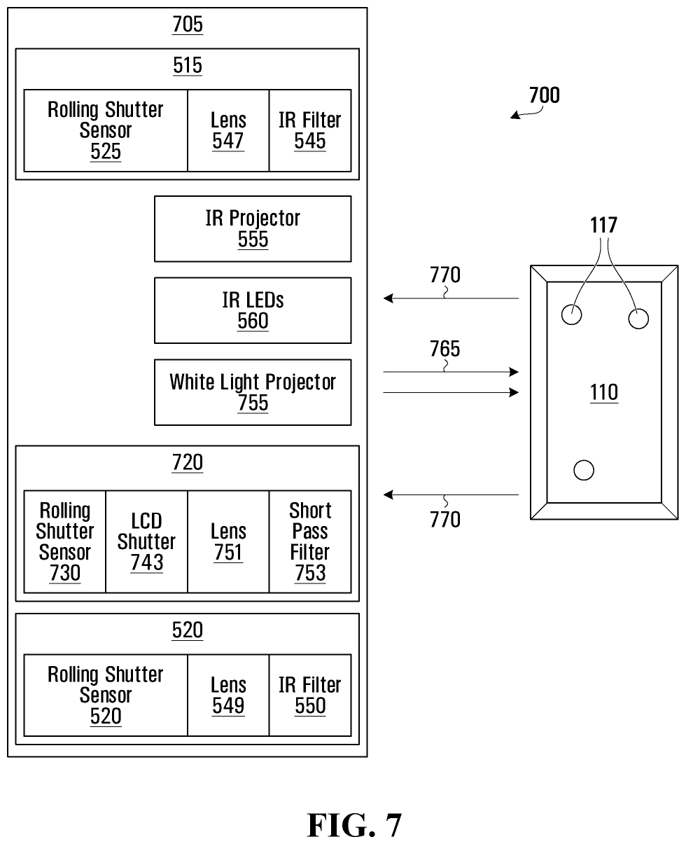

The IR rolling shutter scanner 505 is a variation on the handheld 3D scanner 10 of FIG. 2, where in the imaging modules the first and second cameras 31, 32 are implemented as monochrome, color visible spectrum, or near infrared cameras and the third camera 34 omitted. However, to acquire the color of the object, a scanner needs to acquire data in the visible spectrum. FIG. 7 shows an embodiment of a color scanner 705 that is a variation on the handheld 3D scanner 10 of FIG. 2, where the imaging modules include first and second cameras implemented as rolling shutter cameras 515, 520 as well as a third camera that is a color camera 720. Also included in the imaging modules are two types of light projector units, an IR projector and a white light projector.

Similar to the IR rolling shutter scanner 505, the color scanner 705 includes rolling shutter cameras 515, 520 and IR projector 555, which operate as discussed with respect to FIGS. 5 and 6. The color scanner 705 may also include IR LEDs 560 as discussed above, or the IR LEDs may be omitted.

Also integrated into the color scanner 705 is a rolling shutter color camera 720 (equivalent to the third camera 34). The color camera includes a rolling shutter color sensor 730 (e.g., a CMOS sensor with an array of pixels that is configured as a rolling shutter camera as described above).

In the rolling shutter color camera 720, an LCD shutter 743 is placed in front of the color sensor 730 and behind the lens 751 of the rolling shutter color camera 720. An LCD shutter such as the LCD shutter 743 embodied herein includes two polarizers set at 90 degrees with respect to each other with a liquid crystal liquid in between. As is known in the art, such an LCD shutter transmits light based on the angle of the incident light and allows toggling of the light exposure of the rolling shutter color camera 720 between on and off. The arrangement of the LCD shutter 743 behind the lens 751 (rather than in front of or embedded within the lens) allows the LCD shutter to be smaller in size when located behind the lens compared to if positioned in front of it. Light transmitted through the lens is more parallel, so the position of the LCD shutter has less effect on the color detected. The positioning also relaxes tolerances on the optical quality of the LCD shutter.

Placement of the LCD shutter 743 behind the lens 751 also protects the shutter from the exterior environment and contaminants such as dust. Additionally, as LCD shutters are sensitive to temperature, the placement of the LCD shutter 743 behind the lens 751 enables easier temperature control.

Unlike the IR projector 555 that emits a structured light pattern, the white light projector 755 of the color scanner 705 emits a single “spotlight” of visible light. In some embodiments, the white light projector 755 has the form of white light LEDs. In some embodiments, the white light projector 755 may be omitted, and the rolling shutter color camera 720 makes use of white light in the ambient environment.

The rolling shutter color camera 720 includes a filter for blocking at least in part wavelengths of light corresponding to wavelengths of light projected by the IR light projector unit 555. Accordingly, a shortpass filter 753 is included in the rolling shutter color camera 720, so that the majority of incident light with longer wavelengths (e.g., IR radiation) is not transmitted to the lens 751, the LCD shutter 743, nor the rolling shutter color sensor 730. Incident light 770 that is reflected back from the object 110 includes light emitted 765 by the color scanner 705, which can include both IR light from the IR projector 555 (and IR LEDs 560 if used) as well as visible light from white light projector 755 (if used) and from the ambient environment. Use of a rolling shutter color camera 720 advantageously uses white light and excludes the IR projected light. The color scanner 705 is thus able to acquire the color of the object 110 (from received white light) simultaneously with the geometry and position (from received IR light). Rather than alternating between visible projected light (e.g., from the white light projector 755) and IR projected light (from the IR projector 555), the two types of light can be projected and/or captured simultaneously. IR filters 545, 550 in front of the rolling shutter cameras 515, 520 filter out the white light, and so projected (and ambient) white light does not dilute the signal falling on the rolling shutter sensors 525, 530 that determine the 3D positions of the surface of the object 110. The two types of light do not need to be acquired in alternance with altering patterns of projected light.

One or more processors (e.g., processor 160) are configured for sending control signals to the LCD shutter for toggling the LCD shutter between an open state and a closed state, wherein in the open state the LCD shutter is translucent and wherein in the closed state the LCD shutter is opaque. In the closed state the LCD shutter is at least partially opaque (e.g., blocks at least 40%, more preferably at least 50% or most preferably at least 65%) and, in some implementations, may be fully opaque so that a majority of light is blocked from passing through (e.g., blocks at least 75, more preferably at least 80%, more preferably at least 85% and most preferably at least 95% of the light). In some embodiments, toggling the LCD shutter between the open state and the closed state is timed to interleave with periods of time during which the light projector unit toggles between the activated pattern state (where P1 emits a structured IR light pattern) and the deactivated pattern state. This can occur so that when the light projector unit toggles into the activated pattern state, the LCD shutter also toggles into the open state and when the light projector unit toggles into the deactivated pattern state, the LCD shutter toggles in the closed state. Such an arrangement advantageously allows the geometry data (acquired from the IR structured light pattern) to be acquired at the same instant as the texture data.

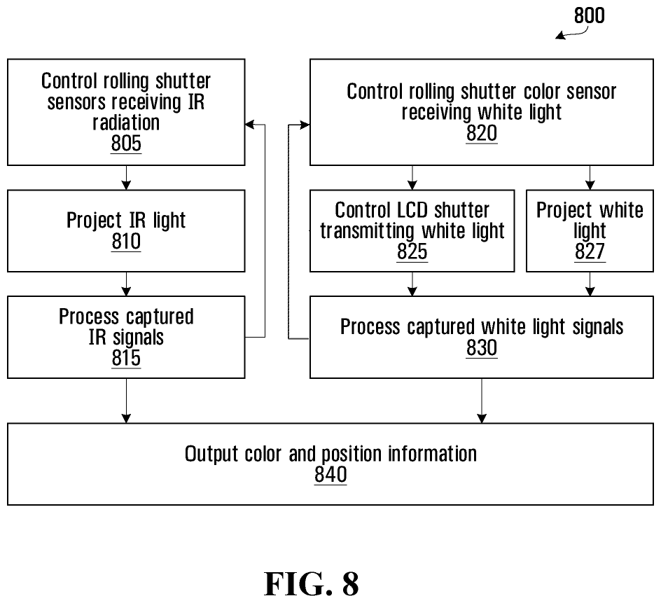

FIG. 8 illustrates a method 800 of using the color scanner 705 of FIG. 8. At step 805, signals are sent to control the behavior of the rolling shutter cameras that are receiving IR light through the IR filters (rolling shutter cameras 515, 520). At step 810, IR light is projected and timed so that all pixels of the rolling shutter cameras receive reflections of the projected IR light. The IR signals are captured and processed, step 815. These steps are repeated and overlapping as discussed above with respect to FIG. 6, where the processor sends control signals to the light projector unit to intermittently project the structured light pattern in accordance with a specific sequence

Simultaneously, at step 820, signals are sent to control the behavior of the rolling shutter camera that is receiving white light. The LCD shutter is controlled to enter the open state (step 825) at the same time that white light is projected (step 827). The white light is projected and timed so that all pixels of the rolling shutter cameras are receiving reflections of the projected white light as permitted by both the rolling shutter and the LCD shutter. Accordingly, the LCD shutter is in the open state at least partially concurrently while the light projector unit is in the activated pattern state and the LCD shutter is in the closed state at least partially concurrently while the light projector unit is in the deactivated pattern state.

The captured white signals are processed, step 830. These steps are repeated. The processed IR signals that are indicative of the 3D surface configuration of the imaged object and the processed white light signals that are indicative of the color and appearance of the imaged object are both output to a user, step 840. All of the steps of method 800 are repeated multiple times to fully characterize an object. Note that step 827 may be omitted in embodiments where the projector unit does not include a white light projector; in such embodiments white light from the environment is received at the LCD shutter. Steps 820 and 825 are repeated over multiple cycles.

### Hardware

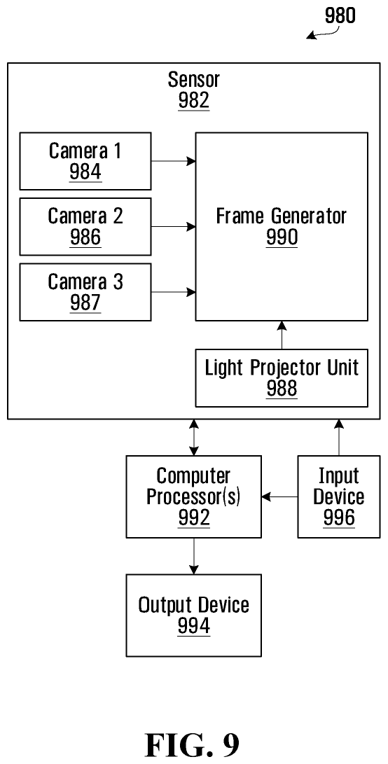

FIG. 9 is a block diagram showing example main components of the system 980. The sensor 982 (e.g., the 3D scanner 100 of FIG. 1) includes a first camera 984 and a second camera 986 as well as a light projector unit 988 including at least one light projector capable of projecting light that could be white or a specific wavelength such as infrared. In some embodiments the sensor 982 also includes a third camera 987. The light projector unit 988 can project IR and/or white light. A frame generator 990 may be used to assemble the images captured by the cameras in a single frame. The sensor 982 is in communications with at least one computer processor 992 (e.g., the processor 160 of FIG. 1) for implementing the processing steps to match points between the images of the frame. The computer processor 992 is in electronic communications with an output device 994 to output the matched points and/or any additional or intermediary outputs. As will be readily understood, it may be necessary to input data for use by the computer processor 992 and/or the sensor 982. Input device(s) 996 can be provided for this purpose.

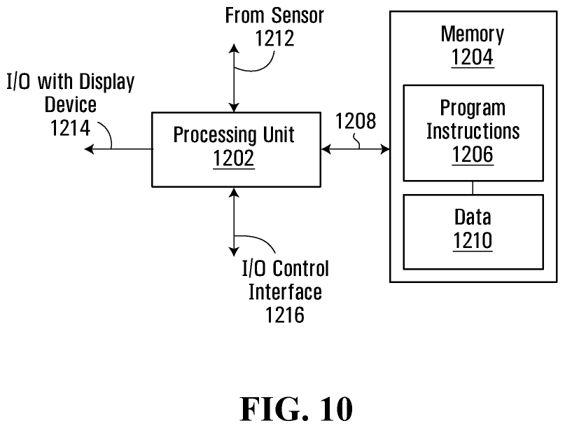

In a non-limiting example, some or all the functionality of the computer processor 992 (e.g., the processor 160 of FIGS. 1A and 1B) may be implemented on a suitable microprocessor 1200, of the type depicted in FIG. 10. Such a microprocessor 1200 typically includes a processing unit 1202 and a memory 1204 that is connected by a communication bus 1208. The memory 1204 includes program instructions 1206 and data 1210. The processing unit 1202 is adapted to process the data 1210 and the program instructions 1206 in order to implement the functionality described and depicted in the drawings with reference to the 3D imaging system. The microprocessor 1200 may also comprise one or more I/O interfaces for receiving or sending data elements to external modules. In particular, the microprocessor 1200 may comprise an I/O interface 1212 with the sensor (the camera), an I/O interface 1214 for exchanging signals with an output device (such as a display device) and an I/O interface 1216 for exchanging signals with a control interface (not shown). The output device and the control interface may be shown on the same interface.

Those skilled in the art should appreciate that in some non-limiting embodiments, all or part of the functionality previously described herein with respect to the processing system may be implemented using pre-programmed hardware or firmware elements (e.g., microprocessors, FPGAs, application specific integrated circuits (ASICs), electrically erasable programmable read-only memories (EEPROMs), etc.), or other related components.

In other non-limiting embodiments, all or part of the functionality previously described herein with respect to a processor 160 of the 3D scanner 100 or 100′ may be implemented as software consisting of a series of program instructions for execution by one or more computing units. The series of program instructions can be tangibly stored on one or more tangible computer readable storage media, or the instructions can be tangibly stored remotely but transmittable to the one or more computing unit via a modem or other interface device (e.g., a communications adapter) connected to a computer network over a transmission medium. The transmission medium may be either a tangible medium (e.g., optical or analog communications lines) or a medium implemented using wireless techniques (e.g., microwave, infrared or other transmission schemes).

The techniques described above may be implemented, for example, in hardware, software tangibly stored on a computer-readable medium, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Those skilled in the art should further appreciate that the program instructions may be written in a number of suitable programming languages for use with many computer architectures or operating systems.

Note that titles or subtitles may be used throughout the present disclosure for convenience of a reader, but in no way these should limit the scope of the invention. Moreover, certain theories may be proposed and disclosed herein; however, in no way they, whether they are right or wrong, should limit the scope of the invention so long as the invention is practiced according to the present disclosure without regard for any particular theory or scheme of action.

All references cited throughout the specification are hereby incorporated by reference in their entirety for all purposes.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although various embodiments of the disclosure have been described and illustrated, it will be apparent to those skilled in the art in light of the present description that numerous modifications and variations can be made. The scope of the invention is defined more particularly in the appended claims.

What is claimed is:

1. A scanner for generating 3D data relating to a surface of a target object, the scanner comprising:
a. a scanner frame structure on which is mounted a set of imaging modules including:
i. a light projector unit for projecting a structured light pattern onto the surface of the target object; and
ii. a set of cameras positioned alongside the light projector unit, said set of cameras including one or more rolling shutter cameras for capturing data conveying a set of images including reflections of the structured light pattern projected onto the surface of the target object, wherein the one or more rolling shutter cameras have sensor surfaces defining a plurality of pixel lines, wherein different pixel lines in the plurality of pixel lines sequentially begin to be exposed over a specific capture cycle; and
b. one or more processors in communication with the set of imaging modules for receiving and processing the data conveying the set of images, wherein the one or more processors are further configured to send control signals to the light projector unit to cause the light projector unit to intermittently project the structured light pattern in accordance with a specific sequence by causing the light projector unit to toggle between an activated pattern state and a deactivated pattern state during the specific capture cycle, wherein:
i. during the activated pattern state, the light projector unit projects the structured light pattern; and
ii. during the deactivated pattern state, the light projector unit:
1. omits to project the structured light pattern; or
2. projects a substantially attenuated version of the structured light pattern;
iii. wherein occurrences of the activated pattern state coincide at least in part with specific time periods of the specific capture cycle during which the plurality of pixel lines are concurrently exposed; and
iv. wherein occurrences of the deactivated pattern state coincide at least in part with other time periods of the specific capture cycle distinct from said specific time periods, wherein during the other time periods:
specific subsets of pixel lines in the plurality of pixel lines are not exposed; and
at least one pixel line in the plurality of pixel lines omitted from the specific subsets is exposed.

2. The scanner as defined in claim 1, wherein the specific capture cycle comprises:
a. the specific time periods during which the pixel lines in the plurality of pixel lines are concurrently exposed; and
b. the other time periods, distinct from the specific time periods, during which specific subsets of pixel lines in the plurality of pixel lines are not exposed.

3. (canceled)

4. The scanner as defined claim 1, wherein the specific capture cycle comprises one of a plurality of specific capture cycles of the one or more rolling shutter cameras.

5. The scanner as defined in claim 4, wherein the one or more processors are further configured to:
a. send a reset signal to the one or more rolling shutter cameras to start a new specific capture cycle of the plurality of specific capture cycles during which the different pixel lines in the plurality of pixel lines are sequentially exposed;
b. following a first delay period after the sending of the reset signal, send an activation control signal to the light projector unit to cause the light projector unit to toggle into the activated pattern state during the new specific capture cycle; and
c. following a second delay period after sending of the activation control signal to the light projector unit, sending a deactivation control signal to the light projector unit to cause the light projector unit to toggle into the deactivated pattern state during the new specific capture cycle.

6. The scanner as defined in claim 4, wherein the one or more processors are further configured to:
a. following a cycle delay period after an end of the specific capture cycle, send a reset signal to the one or more rolling shutter cameras to start a new specific capture cycle.

7. The scanner as defined in claim 1, wherein the light projector unit includes a light source configured for emitting light with wavelengths in a specific wavelength range.

8. The scanner as defined in claim 7, wherein the one or more rolling shutter cameras include at least one rolling shutter geometric camera, said at least one rolling shutter geometric camera being configured for:
a. allowing light with wavelengths in the specific wavelength range to pass through onto the sensor surfaces; and
b. substantially attenuating light with wavelengths outside the specific wavelength range.

9. (canceled)

10. (canceled)

11. (canceled)

12. (canceled)

13. (canceled)

14. (canceled)

15. (canceled)

16. (canceled)

17. (canceled)

18. (canceled)

19. The scanner as defined in claim 1, wherein the one or more rolling shutter cameras include a rolling shutter color camera for generating image data to derive texture information associated with the surface of the target object.

20. The scanner as defined in claim 19, wherein the rolling shutter color camera comprises a liquid crystal device (LCD) shutter.

21. The scanner as defined in claim 20, wherein the rolling shutter color camera comprises:
a. a sensor; and
b. a lens, wherein the liquid crystal device (LCD) shutter is positioned between the sensor and the lens.

22. The scanner as defined claim 20, wherein the one or more processors are further configured to send control signals to the LCD shutter for toggling the LCD shutter between an open state and a closed state, wherein in the open state the LCD shutter is translucent and wherein in the closed state the LCD shutter is at least partially opaque.

23. (canceled)

24. The scanner as defined in claim 22, wherein toggling the LCD shutter between the open state and the closed state at least partially coincides with toggling the light projector unit between the activated pattern state and the deactivated pattern state so that:
a. the LCD shutter is in the open state at least partially concurrently while the light projector unit is in the activated pattern state; and
b. the LCD shutter is in the closed state at least partially concurrently while the light projector unit is in the deactivated pattern state.

25. The scanner as defined in claim 19, wherein the light projector unit is a first light projector unit projecting light of a first type including the structured light pattern, and wherein the scanner comprises a second light projector unit including a second projector light source configured for projecting light of a second type onto the surface on the target object.

26. (canceled)

27. (canceled)

28. The scanner as defined in claim 25, wherein the rolling shutter color camera comprising a filter for blocking at least in part wavelengths of light corresponding to wavelength of light projected by the first light projector unit.

29. (canceled)

30. (canceled)

31. (canceled)

32. (canceled)

33. (canceled)

34. (canceled)

35. (canceled)

36. (canceled)

37. (canceled)

38. A scanning system for generating 3D data relating to a surface of a target object, the scanning system comprising:
a. the scanner as defined in claim 1; and
b. a computing system in communication with said scanner, the computing system being configured for:
i. performing a 3D reconstruction process of the surface of the target object using the data conveying the set of images including the reflections of the structured light pattern captured by the scanner; and
ii. rendering, on a graphical user interface displayed on a display device, a visual representation of at least portion of the surface of the target object resulting from the 3D reconstruction process.

39. A method for generating 3D data relating to a surface of a target object using a 3D scanner, the 3D scanner having a set of imaging modules including a light projector unit and a set of cameras, the light projector unit configured to project a structured light pattern onto the surface of the target object, the set of cameras including one or more rolling shutter cameras configured to capture data conveying a set of images including reflections of the structured light pattern projected onto the surface of the target object, wherein the one or more rolling shutter cameras have sensor surfaces defining a plurality of pixel lines, wherein different pixel lines in the plurality of pixel lines sequentially begin to be exposed over a specific capture cycle, the method comprising:
a. sending control signals to the light projector unit to cause it to intermittently project the structured light pattern according to a specific sequence by toggling the light projector unit between an activated pattern state and a deactivated pattern state during the specific capture cycle, wherein:
i. during the activated pattern state, the light projector unit projects the structured light pattern;
ii. during the deactivated pattern state, the light projector unit:
1. omits to project the structured light pattern; or
2. projects a substantially attenuated version of the structured light pattern;
iii. wherein occurrences of the activated pattern state coincide at least in part with specific time periods of the specific capture cycle during which the plurality of pixel lines are concurrently exposed; and
iv. wherein occurrences of the deactivated pattern state coincide at least in part with other time periods of the specific capture cycle distinct from said specific time periods, wherein during the other time period:
specific subsets of pixel lines in the plurality of pixel lines are not exposed; and
at least one pixel line in the plurality of pixel lines omitted from the specific subset is exposed.

40. The method as defined in claim 39, wherein the specific capture cycle comprises:
a. the specific time periods during which the pixel lines in the plurality of pixel lines are concurrently exposed; and
b. the other time periods, distinct from the specific time periods, during which specific subsets of pixel lines in the plurality of pixel lines are not exposed.

41. (canceled)

42. The method as defined in claim 39, wherein the specific capture cycle comprises one of a plurality of specific capture cycles of the one or more rolling shutter cameras.

43. The method as defined in claim 42, further comprising:
a. sending a reset signal to the one or more rolling shutter cameras to start a new specific capture cycle of the plurality of specific capture cycles during which the different pixel lines in the plurality of pixel lines are sequentially exposed;
b. following a first delay period after sending the reset signal, sending an activation control signal to the light projector unit to cause the light projector unit to toggle into the activated pattern state during the new specific capture cycle; and
c. following a second delay period after sending of the activation control signal to the light projector unit, sending a deactivation control signal to the light projector unit to cause the light projector unit to toggle into the deactivated pattern state during the new specific capture cycle.

44. The method as defined in claim 42, further comprising:
a. following a cycle delay time period after an end of the specific capture cycle, sending a reset signal to the one or more rolling shutter cameras to start a new specific capture cycle of the plurality of specific capture cycles.

45. The method as defined in claim 39, wherein the one or more rolling shutter cameras include a rolling shutter color camera for generating image data to derive texture information associated with the surface of the target object, and wherein the rolling shutter color camera comprises a liquid crystal device (LCD) shutter, said method further comprising:
a. sending control signals to the LCD shutter for toggling the LCD shutter between an open state and a closed state, wherein in the open state the LCD shutter is translucent and wherein in the closed state the LCD shutter is at least partially opaque.

46. The method as defined in claim 45, wherein toggling the LCD shutter between the open state and the closed state at least partially coincides with toggling the light projector unit between the activated pattern state and the deactivated pattern state such that:
a. the LCD shutter is in the open state at least partially concurrently while the light projector unit is in the activated pattern state; and
b. the LCD shutter is in the closed state at least partially concurrently while the light projector unit is in the deactivated pattern state.

47. (canceled)

48. (canceled)

49. (canceled)

50. (canceled)

51. (canceled)

52. (canceled)

53. A scanner for generating 3D data relating to a surface of a target object, the scanner comprising:
a. a scanner frame structure on which is mounted a set of imaging modules including:
i. a light projector unit for projecting a structured light pattern onto the surface of the target object, the light projector unit having a light source configured for emitting light with wavelengths in a specific wavelength range, wherein the light projector unit is configured to intermittently project the structured light pattern by operating in one of:
1. an activated pattern state, during which the light projector unit projects the structured light pattern onto the surface of the target object; or
2. a deactivated pattern state, during which the light projector unit omits to project the structured light pattern onto the surface of the target object or projects a substantially attenuated version of the structured light pattern; and
ii. a set of cameras positioned alongside the light projector unit, said set of cameras including one or more rolling shutter cameras for capturing data conveying a set of images including reflections of the structured light pattern projected onto the surface of the target object, the one or more rolling shutter cameras having sensor surfaces defining a plurality of pixel lines and operating in a specific capture cycle during which individual pixel lines in the plurality of pixel lines are sequentially exposed, wherein the one or more rolling shutter cameras includes at least one rolling shutter geometric camera for generating image data to derive 3D measurements of the surface of the target object and wherein the at least one rolling shutter geometric camera is configured to:
1. allow light with wavelengths in the specific wavelength range to pass through onto the sensor surfaces; and
2. substantially attenuate light in spectrums outside the specific wavelength range, and
b. wherein the light projector unit and the set of cameras are configured such that:
i. occurrences of the activated pattern state of the light projector unit coincide at least in part with time periods during which the plurality of pixel lines defined by the sensor surfaces of at least one of the one or more rolling shutter cameras are concurrently exposed in the specific capture cycle; and
ii. occurrences of the deactivated pattern state of the light projector unit coincide at least in part with time periods during which subsets of the individual pixel lines in the plurality of pixel lines cease to be exposed for the specific capture cycle.

54. The scanner as defined in claim 53, wherein the sensor surfaces of the one or more rolling shutter cameras are activated in accordance with an operating pattern as part of the specific capture cycle, the operating pattern being characterized by:
a. specific time periods during which the individual pixel lines in the plurality of pixel lines are concurrently exposed in the specific capture cycle; and
b. other time periods, distinct from the specific time periods, during which specific subsets of the individual pixel lines in the plurality of pixel lines cease to be exposed for the specific capture cycle, wherein the specific subsets of the individual pixel lines omit at least some of the individual pixel lines in the plurality of pixel lines.

55. The scanner as defined in claim 53, wherein the one or more rolling shutter cameras are further configured to start a new specific capture cycle for the plurality of pixel lines during which the individual pixel lines in the plurality of pixel lines are sequentially exposed for the new specific capture cycle.

56. The scanner as defined in claim 55, wherein the light projector unit is configured to:
a. following a first delay period after the start of the new specific capture cycle, start operation in the activated pattern state; and
b. following a second delay period after the start of operation in the activated pattern state, start operation in the deactivated pattern state.

57. The scanner as defined in claim 53, wherein the specific wavelength range is an infrared wavelength range, a white light wavelength range, or a blue light wavelength range.

58. The scanner as defined in claim 53, wherein the at least one rolling shutter geometric camera comprises at least two rolling shutter geometric cameras.

59. The scanner as defined in claim 58, wherein the at least one rolling shutter geometric camera includes a near infrared camera, the near infrared camera including an infrared filter configured to let infrared light pass and to substantially attenuate light in spectrums outside infrared.

60. The scanner as defined in claim 53, wherein the light projector unit is configured to intermittently project the structured light pattern in a periodic sequence so that the light projector unit intermittently projects the structured light pattern onto the surface of the target object at regular time intervals.

61. The scanner as defined in claim 53, wherein the one or more rolling shutter cameras further includes a rolling shutter color camera for generating image data to derive texture information associated with the surface of the target object, the rolling shutter color camera comprising:
a. a sensor;
b. a lens; and
c. a liquid crystal device (LCD) shutter positioned between the sensor and the lens, wherein the LCD shutter operates in one of an open state or a closed state, wherein in the open state the LCD shutter is translucent and wherein in the closed state the LCD shutter is at least partially opaque.

62. The scanner as defined in claim 61, wherein the LCD shutter and the light projector unit are configured such that operation of the LCD shutter in the open state or the closed state at least partially coincides with operation of the light projector unit in the activated pattern state or the deactivated pattern state so that:
a. the LCD shutter operates in the open state at least partially concurrently while the light projector unit operates in the activated pattern state; and
b. the LCD shutter operates in the closed state at least partially concurrently while the light projector unit operates in the deactivated pattern state.

63. The scanner as defined in claim 53, further comprising one or more processors in communication with the set of imaging modules and configured to:
a. receive and process the data conveying the set of images including the reflections of the structured light pattern to perform a 3D reconstruction process of the surface of the target object; or
b. transmit the data conveying the set of images including the reflections of the structured light pattern to a remote computing system distinct from the scanner, the remote computing system being configured for performing the 3D reconstruction process of the surface of the target object using the data conveying the set of images including the reflections of the structured light pattern.

64. The scanner as defined in claim 53, wherein the scanner is a handheld scanner.
